(19) United States
(12) Patent Application Publication
(10) Pub. No.: US 2007/0149017 A1
(43) Pub. Date: Jun. 28, 2007

(54) Card connector with an ejector

(75) Inventors: Chang-Shin Hsu, Tu-Cheng (TW); Gao-Wen Zhao, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/645,408

(22) Filed: Dec. 26, 2006

(30) Foreign Application Priority Data
Dec. 23, 2005 (CN) 200510022628.2

(51) Int. Cl. H01R 13/62

(52) U.S. Cl. 439/159

(57) ABSTRACT

A card connector adapted for receiving a card comprises an insulating housing (1) defining a card receiving space with a card insertion/ejecting direction; a plurality of contacts (2) retained in the insulating housing and an ejector (3) received in the insulating housing for ejecting the card. The ejector comprises a slider (30) movable along the card insertion/ejecting direction, a resilient member (31), a pin member (32) and a latching member (33) retained to the slider and having a locking portion (330), during an insertion process of the card, the latching member moves upwardly together with the slider, and brings the locking portion to move upwardly and lock the card.

### BACKGROUND OF THE INVENTION

1. Field of the Invention

The present invention is generally related to a card connector, and especially to a card connector adapted a card.

2. Description of Related Art

Card connectors are widely used in variety electrical equipments for building electrical paths between the electrical equipments and electrical cards, which are used as storage devices. Usually, card connectors are provided with ejectors to eject electrical cards received in the card connectors, and some have locking members assembled on the ejectors to prevent the electrical cards from pulling out by mistake during working.

A card connector comprises an insulating housing with a plurality of contacts and an ejector receive in the insulating housing for ejecting a card. The ejector has a locking arm retained to a slider for locking with the card. The insulating housing defines a gap on a sidewall besides the ejector thereof, a free end of the locking arm faces to the gap when the slider is at an initial position and staggers with the gap when the slider is at a final position after the card inserted into the insulating housing. That means the locking arm is movable outwardly and away from the card by the free end entering the gap at the initial position and is kept locking with the card at the final position, where the sidewall of the insulating housing limits the free end of the locking arm. However, the intensity of the sidewall is reduced by the gap, so the sidewall is destroyed easily when the card is pulled at the final position by mistake.

Hence, an improved card connector is highly desired to overcome the aforementioned disadvantages of the prior art.

### SUMMARY OF THE INVENTION

Accordingly, an object of the present invention is to provide a card connector which can prevent the card from being pulled out by mistake in a normal working station.

To achieve the above object, a card connector adapted for a card comprises an insulating housing defining a card receiving space with a card insertion and ejecting direction, a plurality of contacts retained in the insulating housing, and an ejector received in the insulating housing for ejecting the card. The ejector comprises a slider formed with a heart-shaped slot and movable along the card insertion and ejecting direction, a resilient member, a pin member and a latching member retained to the slider and having a locking portion. During an insertion process of the card, the latching member moves upwardly together with the slider, and brings the locking portion to move upwardly to lock the card.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled, perspective view of a card connector in accordance with the present invention with a card therein;

FIG. 2 is an exploded, perspective view of the card connector in accordance with the present invention;

FIG. 3 is a partially exploded, perspective view of the card connector in accordance with the present invention;

FIG. 4 is a perspective view of the card connector in FIG. 1, wherein a shell is not assemble to an insulating housing; and

FIG. 5 is a perspective view similar with FIG. 4, showing a card inserted into the card connector and engaging with the ejector.

### DETAILED DESCRIPTION OF THE INVENTION

Reference will now be made in detail to the preferred embodiment of the present invention.

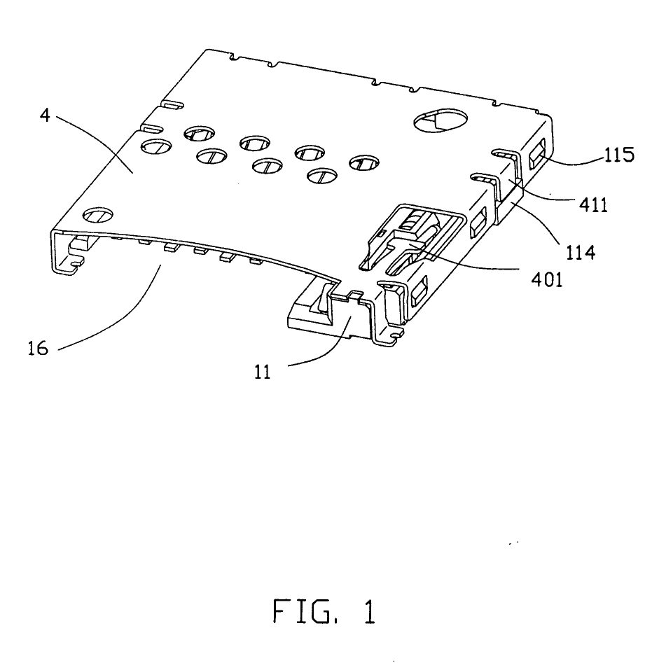

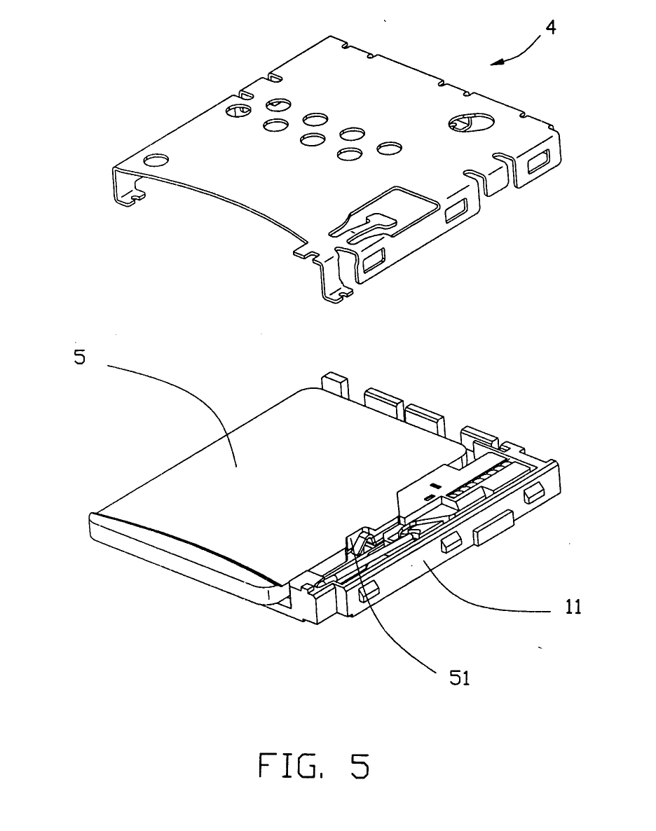

Referring to FIGS. 1-2 and 5, the card connector in accordance with the present invention is adapted for receiving a card 5, such as a SIM card. The card connector comprises an insulating housing 1, a plurality of contacts 2 received in the insulating housing 1, an ejector 3 and a shell 4.

Referring to FIG. 1-3, the insulating housing 1 is approximately a rectangle configuration. The insulating housing 1 comprises a bottom wall 13, a sidewalls 11 extending upwardly from a lateral edge of the bottom wall 13, and a discontinuous rear wall 14 extending upwardly from a rear edge of the bottom wall 13, which commonly together define a card receiving space 16 for accommodating the card 5 with a card insertion and ejection direction. The bottom wall 13 has an U-shaped frame (not labeled) and a bridge 12 linking two opposed sides of the U-shaped frame, an opening 15 is defined in the center of the bottom wall 13. The bridge 12 defines a plurality of retaining channels 120 for retaining the contacts 2.

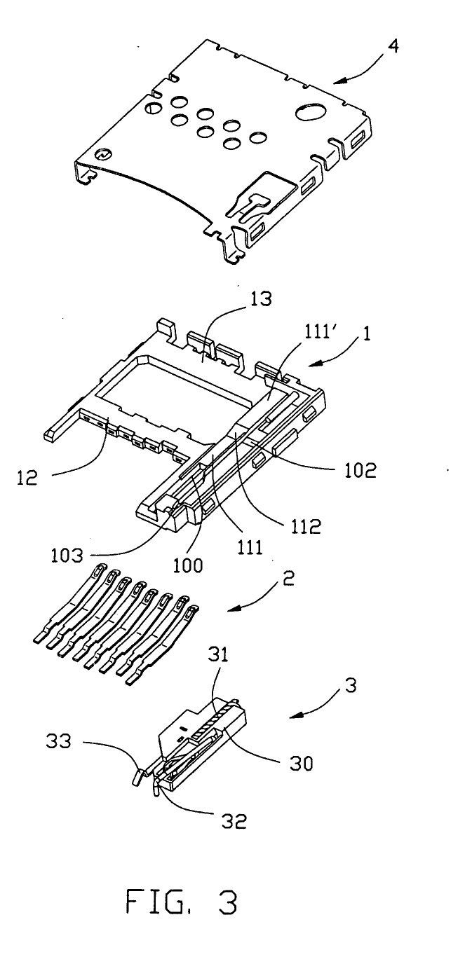

The bottom wall 13 has a rib 110 adjacent to the sidewall 11 and a through hole 100 in front of the rib 110, both the rib 110 and the hole 100 extend along the card insertion and ejection direction. A slot 101 defined between the rib 110 and the sidewall 11 is used for guiding the ejector 3, an inner side surface of rib 110 can guide the card 5. The rib 110 is formed with a step on a top surface thereof by an inline surface 112 linking a high rear portion 111′ and a low front portion 111 (referring to FIG. 3). The bottom wall 13 further accordingly forms another step 102 in the slot 101 according to the step of the rib 110 for placidly guiding the ejector 3. The sidewall 11 is provided with a blocking wall 113 in front of the slot 101.

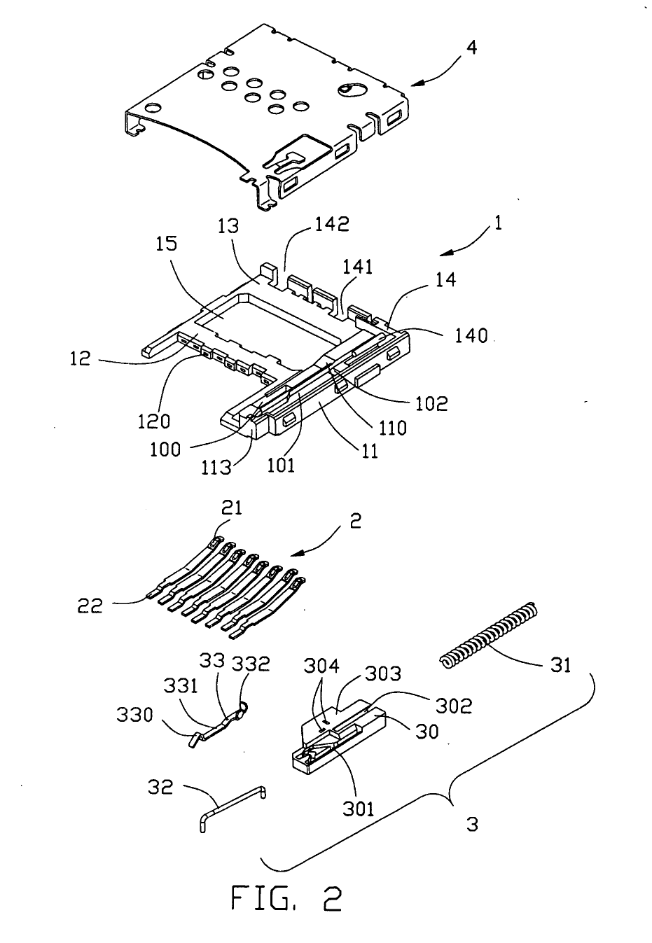

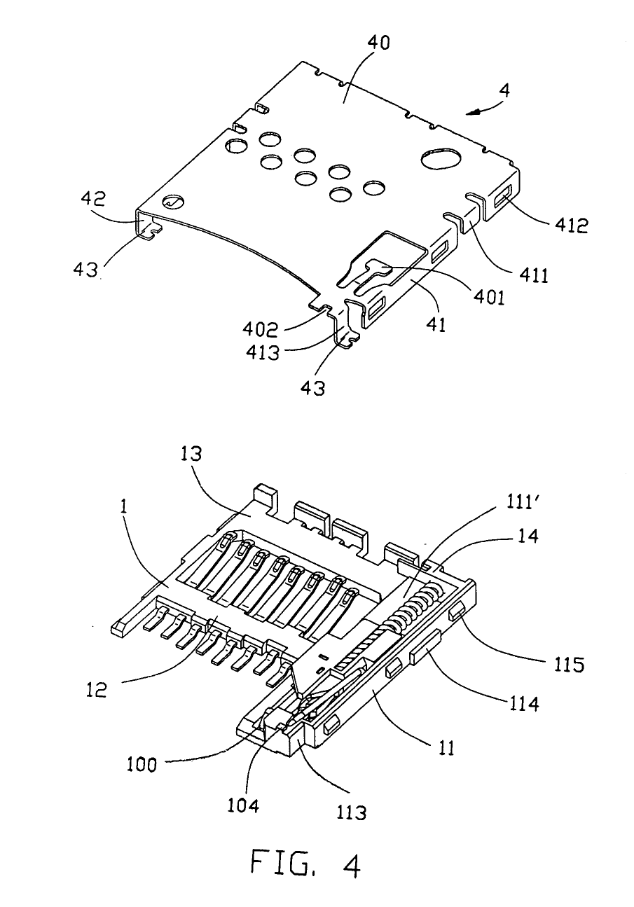

Referring to FIGS. 2 and 4, Each contact 2 has a contacting portion 21, a retaining portion (not labeled) and a soldering portion 22 for being soldered to a print circuit board. When the contacts 2 are assembled to the bridge 12, the retaining portions are received in the retaining channels 120, the contacting portions 21 are upon the opening 15 and extend into the card receiving space 16 for electrically contacting with the card 5.

Referring to FIGS. 2-4, the ejector 3 is used for ejecting the card 5 out of the card connector. The ejector 3 comprises a slider 30 movable along the card insertion and ejecting direction with the card 5 inserted and ejected, a resilient member 31 urging the slider 30 toward the card ejecting direction, a pin member 32 and a latching member 33 retained to the slider 30. In this embodiment, the resilient member 31 is a spring. The slider 30 defines a heart-shaped slot 301 recessed downwardly from a top surface thereof, a receiving hole 302 recessed forwardly from a rear face thereof for receiving the resilient member 31 and has an ejecting portion 303 on an inner side thereof for ejecting the card 5 directly. The pin member 32 and the heart-shaped slot 301 are referred as a holding equipment, which can hold the slider 30 and the card 5 in a final position where the card 5 is electrically connected with the card connector completely, and can release the slider 30 when ejecting the card 5.

The latching member 33 is a metal slice and has a body 331, a locking portion 330 on a free end of the body 331 and a pair of tabs 332 on the other end of the body 331. The tabs 332 insert into gaps 304 defined on the ejecting portion 303 the slider 30 to retain the latching member 33 to the slider 30 in a bottom-to-top direction. The locking portion 330 is exposed outside the slider 30 after assembled to the slider 30 for locking the card 5.

The ejector 3 is received in to the insulating housing 1, the slider 30 together with the latching member 33 is movably received in the slot 101 of the insulating housing 1; one end of the spring 34 is disposed around a column 140 formed on the rear wall 14 and the other end is set in the receiving hole 302 of the slider 30; one end of the pin member 32 is moveably disposed in the heart-shaped slot 301 of the slider 30 and the other end is securely locked in a hole 103 formed on the blocking wall 113 (referring to FIG. 3). The locking portion 330 of the latching member 33 is able to move downwardly into the hole 100 on the bottom wall 13 before the card 5 pushes the slider 30, the locking portion 303 can be upon the hole 100 or received in the hole 100. Detail descriptions about the locking portion 303 engaging with the card 5 will be given hereinafter.

Referring to FIG. 4, the shell 4 is made of metal sheet to cover the insulating housing 1. The shell 4 comprises a top plate 40, a pair of opposite right and left side portions 41, 42 extending downwardly from lateral sides of the top plate 40. The side portions 41, 42 are formed with a pair of soldering feet 43 respective on opposite front ends for being mounted on a printed circuit board (not shown). Each of side portions 41, 42 also provides an engaging piece 411 and a plurality of mating holes 412, the insulating housing 1 is formed with a protruding block 114 and a plurality of wedges 115 to mate with the corresponding mating holes 412 and the engaging piece 411, respectively. The side portion 41 has a vertical arm 413 engaging with a front corner of the insulating housing 1 besides the blocking wall 113. By this way, the shell 4 is securely assembled to the insulating housing 1. Furthermore, the top plate 40 is formed with a pressing finger 401 for pressing the pin member 32 and a gap 402 on a front edge thereof, the insulating housing 1 has a projection 104 on the blocking wall 13 for inserting into the gap 402 to position the shell 4 in a lateral direction.

Referring to FIGS. 3-5, the card 5 inserts into the card connector and drives the slider 30 to move along the card insertion direction and to urge the resilient member 31 to elastically distort. In the meantime, the pin member 32 moves along the heart-shaped slot 301 to make the slider 30 finally achieve the final position. When ejecting the card 5, a rearward push force is exerted to the card 5 to make the pin member 32 release the slider 30 from the final position to eject the card 5 out of the card connector by the resilient restorable force of the resilient member 31.

The card 5 defines a cutout 51 on a lateral side corresponding to the locking portion 330 of the latching member 33 when the card 5 inserts into the card connector. The locking portion 330 of the latching member 33 can be received in or downwardly move through the hole 100 on the bottom wall 13 when the slider 30 is at an initial position. Then the slider 30 is pushed by the inserting card 5 to move forwardly and upwardly against the top surface of the rib 110 from the low front portion 111 to the high rear portion 111′, while the card 5 just moves forwardly. So, the locking portion 330 retained to the slider 30 moves upwardly relative to the card 5 and inserts into the cutout 51 to lock the card 5 with the slider 30. At the time, the slider 30 arrives the final position, the locking portion 330 faces to the low front portion 111, not the hole 100, so the slider 30 is kept in the cutout 51. When the slider 3 return to the initial position, the locking portion 330 faces the hole 100 again and release the locking to the card 5.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector comprising:
an insulating housing defining a card receiving space with a card insertion and ejecting direction;
a plurality of contacts retained in the insulating housing;
an ejector received in the insulating housing for ejecting the card and comprising a slider with a heart-shaped slot, a pin member, a resilient member urging the slider toward the card ejecting direction and a latching member retained to the slider and having a locking portion, during an insertion process of the card, the latching member moving upwardly together with the slider, and bringing the locking portion to move upwardly and lock the card.

2. The card connector as described in claim 1, wherein the insulating housing has a bottom wall, the bottom wall is formed with a rib under the slider for guiding the slider and a hole in front of the rib for receiving the locking portion, both the rib and the hole extend along the card insertion and ejecting direction.

3. The card connector as described in claim 2, wherein the rib is formed with a step with an incline surface for guiding the slider moving upwardly.

4. The card connector as described in claim 3, wherein the slide defines an initial position and a final position, the locking portion of the latching member can be received in the hole before the slider moves from the initial position.

5. The card connector as described in claim 4, wherein when the slider is at the final position, the locking portion is kept locking with the card by the rib.

6. The card connector as described in claim 5, wherein the latching member has a body, a locking portion on a free end of the body and at least one tab on the other end of the body.

7. The card connector as described in claim 6, wherein the slider is formed with an ejecting portion for ejecting the card directly, the ejecting portion defines at least one gap for receiving the corresponding tab to retain the latching member to the slider in a bottom-to-top direction.

8. The card connector as described in claim 3, wherein the bottom wall has an U-shaped frame and a bridge linking two opposed sides of the U-shaped frame defining a plurality of retaining channels for retaining the contacts.

9. A card connector comprising:
an insulative housing defining a bottom base with an opening therein;
a plurality of contacts disposed in the housing with corresponding contacting portion extending into the opening with contacting apexes located above the opening;
a card receiving space located in the housing and above said opening;
a slider moveable in a side channel of the housing beside said card receiving space;
an engagement face formed on the slider for engagement with an inserted card;
a deflectable locking arm with an upward locking head assembled to the slider and deflectable relative to the slider in an upward direction; and
two levels structure formed on the bottom base to actuate the deflectable locking arm to upwardly move when the slider is moved to an inner position by the inserted card so as to have the locking head enters a notch of the inserted card for locking the card inside the housing.

10. The card connector as claimed in claim 9, wherein a bottom base further defines an inclination between two levels of the two levels structure.

11. The card connector as claimed in claim 9, wherein said bottom base defines a large cutout in a front portion to expose soldering portions of the contacts.

12. The card connector as claimed in claim 9, wherein the bottom base defines a slot to receive the deflectable locking arm therein.

13. A card connector comprising:
an insulative housing defining a bottom base with an opening therein;
a plurality of contacts disposed in the housing with corresponding contacting portion extending into the opening with contacting apexes located above the opening;
a card receiving space located in the housing and above said opening;
a shell associated with the housing and covering said card receiving space;
a slider moveable in a side channel of the housing beside said card receiving space;
an engagement face formed on the slider for engagement with an inserted card;
a deflectable locking arm with a locking head assembled to the slider and deflectable relative to the slider in a vertical direction; and
two levels structure formed on one of said the bottom base and the shell to actuate the deflectable locking arm to vertically move when the slider is moved to an inner position by the inserted card so as to have the locking head enters a notch of the inserted card for locking the card inside the housing.

14. The card connector as claimed in claim 13, wherein a bottom base further defines an inclination between two levels of the two levels structure.

15. The card connector as claimed in claim 13, wherein said bottom base defines a large cutout in a front portion to expose soldering portions of the contacts.

16. The card connector as claimed in claim 13, wherein the bottom base defines a slot to receive the deflectable locking arm therein.
